(19) United States
(12) Patent Application Publication
(10) Pub. No.: US 2019/0057312 A1
(43) Pub. Date: Feb. 21, 2019

(54) METHOD AND SYSTEM FOR PROVIDING TRANSPORTATION SERVICE

(71) Applicant: BEINING DIDI INFINITY TECHNOLOGY AND DEVELOPMENT CO., LTD., Beijing (CN)

(72) Inventors: Lu Li, Beijing (CN); Niping Zhang, Beijing (CN); Mingshan Luo, Beijing (CN); Guojun Li, Beijing (CN)

(73) Assignee: BEIJING DIDI INFINITY TECHNOLOGY AND DEVELOPMENT CO., LTD., Beijing (CN)

(21) Appl. No.: 15/858,720

(22) Filed: Dec. 29, 2017

(30) Foreign Application Priority Data
Aug. 16, 2017 (CN) 201710703109.5

(51) Int. Cl. G06N 5/04

(52) U.S. Cl. CPC G06N 5/04; G06Q 2240/00

(57) ABSTRACT

Methods and systems for providing transportation service are described. The method may include receiving, from a passenger terminal, a transportation service request indicating a first type of service vehicle. The method may further include determining route information associated with the transportation service request, and determining an estimated waiting time for the transportation service request to be fulfilled based on the first type of service vehicle and the route information. The method may also include comparing the estimated waiting time to a predetermined time period, and when the estimated waiting time is equal to or longer than the predetermined time period, determining a second type of service vehicle. The second type of service vehicle may have an estimated waiting time shorter than the predetermined time period. The method may also include transmitting, to the passenger terminal, a message recommending the second type of service vehicle.

### CROSS REFERENCE TO RELATED APPLICATION

The present application is based on and claims the benefits of priority to Chinese Application No. 201710703109.5, filed Aug. 16, 2017, the entire contents of which are incorporated herein by reference.

### TECHNICAL FIELD

The present application relates to the field of providing transportation service, and more particularly, to methods and systems for recommending transportation services that have shorter waiting times to passengers through an online hailing platform.

### BACKGROUND

An online hailing platform (e.g., DiDi™ online) can receive a transportation service request from a passenger and then route the service request to at least one transportation service provider (e.g., a taxi driver, a private car owner, or the like). The service request can be picked up by a service provider, or assigned to a service provider if no one picks up the service request within a predetermined period. As such, online hailing has brought great convenience to both passengers and drivers.

The success of arranging transportation mission via the online hailing platform may depend on the matching condition between the demand and the supply of the transportation service. During situations when the demand exceeds the supply, such as morning and evening rush hours, extreme weather, etc., passengers may have difficulty in booking a service vehicle or experience long waiting times. For example, when an online hailing platform receives transportation service requests more than the transportation capacity that the service vehicles can offer at the current moment (e.g., in rush hours), the transportation service requests can be lined up in a queue, where the service vehicles can be assigned with the transportation service requests according to a predetermined regulation. Therefore, in rush hours, a passenger may have to wait in a queue until his/her transportation service request is assigned to a vehicle. Although the online hailing platform can provide an estimated waiting time for each passenger in the queue, the waiting time may get too long and hurt user experience.

The disclosed systems and methods for providing transportation service are directed to mitigating or overcoming one or more of the problems set forth above and/or other problems in the prior art.

### SUMMARY OF INVENTION

Embodiments of the disclosure provide a computer-implemented method for providing transportation service. The method may include receiving, from a passenger terminal, a transportation service request indicating a first type of service vehicle. The method may also include determining route information associated with the transportation service request, and determining an estimated waiting time for the transportation service request to be fulfilled based on the first type of service vehicle and the route information. The method may also include comparing the estimated waiting time to a predetermined time period, and when the estimated waiting time is equal to or longer than the predetermined time period, determining a second type of service vehicle. The second type of service vehicle may have an estimated waiting time shorter than the predetermined time period. The method may also include transmitting, to the passenger terminal, a message recommending the second type of service vehicle.

Embodiments of the disclosure further disclose a device for providing transportation service. The device may include a communication interface in communication with a passenger terminal. The device may also include a memory storing instructions. The device may further include a processor coupled to the communication interface and the memory. The processor is configured to execute the instructions to receive, via the communication interface, a transportation service request from the passenger terminal. The transportation request indicates a first type of service vehicle. The processor may also execute the instructions to determine route information associated with the transportation service request. The processor may also execute the instructions to determine an estimated waiting time for the transportation service request to be fulfilled based on the first type of service vehicle and the route information. The processor may also execute the instructions to compare the estimated waiting time to a predetermined time period. When the estimated waiting time is equal to or longer than the predetermined time period, the processor may execute the instructions to determine a second type of service vehicle. The second type of service vehicle has an estimated waiting time shorter than the predetermined time period. The processor may then execute the instructions to transmit, via the communication interface, a message recommending the second type of service vehicle to the passenger terminal.

Embodiments of the disclosure further disclose a non-transitory computer-readable medium that stores a set of instructions, when executed by at least one processor, causing the at least one processor to perform a method for providing transport service. The method may include receiving, from a passenger terminal, a transportation service request indicating a first type of service vehicle. The method may also include determining route information associated with the transportation service request, and determining an estimated waiting time for the transportation service request to be fulfilled based on the first type of service vehicle and the route information. The method may also include comparing the estimated waiting time to a predetermined time period, and when the estimated waiting time is equal to or longer than the predetermined time period, determining a second type of service vehicle. The second type of service vehicle may have an estimated waiting time shorter than the predetermined time period. The method may also include transmitting, to the passenger terminal, a message recommending the second type of service vehicle.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram illustrating an exemplary system for providing transportation service, according to embodiments of the present disclosure.

FIG. 2 is a schematic diagram illustrating an exemplary passenger terminal used in the system of FIG. 1, according to embodiments of the present disclosure.

FIG. 3 is a flowchart of a first exemplary method for providing transportation service, according to embodiments of the present disclosure.

FIG. 4 is a flowchart of a second exemplary method for providing transportation service, according to embodiments of the present disclosure.

### DETAILED DESCRIPTION

Exemplary embodiments will be described in detail herein, and examples thereof are shown in the accompanying drawings. It is appreciated that exemplary embodiments and features described in exemplary embodiments can be combined in any ways consistent with embodiments of the present disclosure. Implementations described in the following exemplary embodiments do not represent all implementations consistent with the present application. In contrast, the) are merely examples of apparatuses and methods consistent with some aspects of the present application as described in detail in the appended claims.

The disclosed embodiments are directed to computer systems and methods for providing transportation service. In practice, an online hailing platform may provide multiple different types of transportation service for a passenger to choose. These different types of transportation service may differ on the types of service vehicles that the passengers can use. As used herein, information relevant to a type of service vehicle includes, but is not limited to, passenger limit, vehicle model, or vehicle brand of a service vehicle. For example, the different types of transportation service may include, but are not limited to: a regular service offering regular sedans like Toyota™, Prius™, Honda™ Accord™, etc., which can seat up to four passengers; a large-vehicle service offering SUVs or minivans, which can seat up to six passengers but cost more than sedans; an entry-level luxury service offering vehicles of selected brands like BMW™, Mercededs™, Audi™, etc., with a leather interior; and a luxury service offering a limousine, such as a black SUV or luxury sedan.

Consistent with the disclosed embodiments, an online hailing platform may offer multiple different types of transportation service, such as carpooling, regular taxi, private car, premier car service, limousine, etc. As described above, the online hailing platform often faces situations in which the overall demand for transportation services exceeds the overall supply of transportation services. However, even in these situations, the different types of transportation service provided by the platform may have different demand-supply conditions. For example, some types of transportation service, such as carpooling, regular taxi, private car, etc., may have a severe shortage of service vehicles (i.e., long waiting times for the passengers), while other types of transportation service, such as premier car service, limousine, etc., may only have a slight shortage of service vehicles or even have a surplus of service vehicles (i.e., shorter waiting times for the passengers). As described in more detail below, to best use the available transportation capacity and shorten the passengers' waiting times, the disclosed systems and methods may recommend those types of transportation service with less shortage to the passengers.

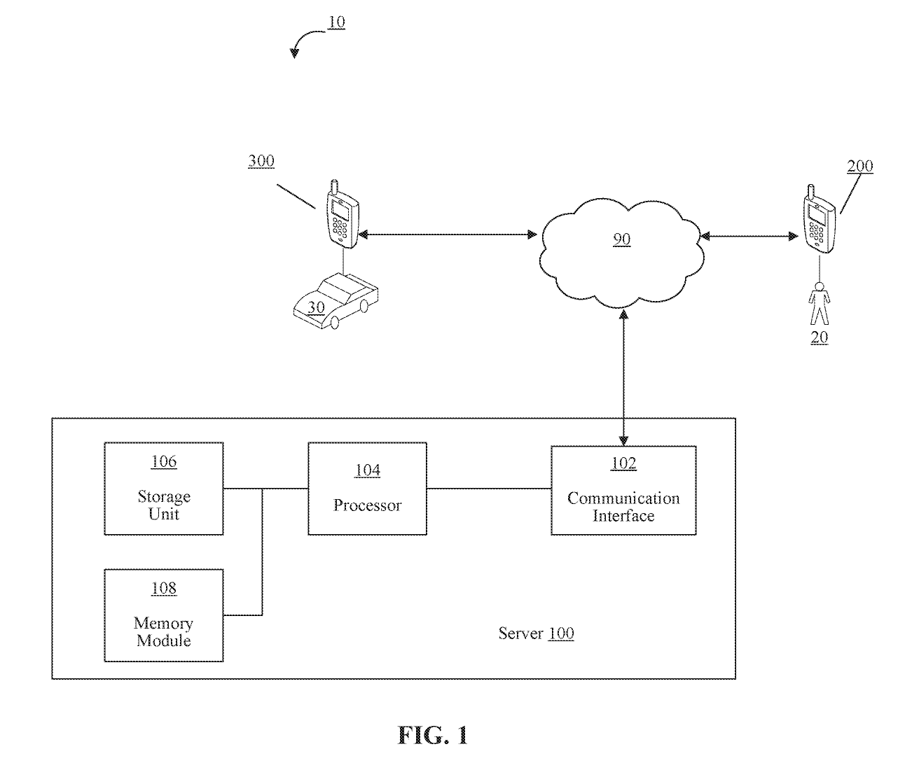

FIG. 1 is a schematic diagram illustrating an exemplary system 10 for providing transportation service, according to embodiments of the present disclosure.

Referring to FIG. 1, system 10 may include a server 100 for providing transportation service. Server 100 may be a general-purpose server or a proprietary device specially designed for managing transportation service requests. It is contemplated that, server 100 can be a separate system or an integrated component of a larger computing system. In some embodiments, server 100 may include sub-systems, some of which may be remote.

Consistent with the disclosed embodiments, server 100 may include, among other things, a communication interface 102, a processor 104, a storage unit 106, and a memory module 108. At least some of these components of server 100 may be configured to transfer data and send or receive instructions between or among each other.

Communication interface 102 may be configured to communicate with one or more passengers 20 and service vehicles 30. Specifically, each passenger 20 may have an associated passenger terminal 200 used for communicating with server 100. For example, passenger terminal 200 may be a smart phone, a tablet, a wearable device, a computer, or the like. Passenger 20 may use passenger terminal 200 to send a transportation service request to server 100. The transportation service request may include a current location of passenger 20, an origin and a destination of the requested transportation service, a request time, or the like. Generally, the origin of the requested transportation service can overlap with a location of passenger 20 and/or passenger terminal 200. However, it is contemplated that the origin of the requested transportation can also differ from the location of passenger terminal 200, even if the transportation service request is sent from passenger terminal 200. For example, a user can request a transportation service from a computer for her friend, who is distant from this user.

Similarly, each service vehicle 30 may have an associated communication device 300 used for communicating with server 100. Consistent with the disclosed embodiments, communicating device 300 may be integrated in vehicle 30, or may be a mobile terminal, e.g., a smart phone, a tablet computer, a wearable device, etc., carried by the driver of vehicle 30. Communication interface 102 may receive vehicle information of service vehicle 30 from communication device 300. Service vehicle 30 may be a taxi car or a private car. It is contemplated that service vehicle 30 can also be an autonomous vehicle. The vehicle information may include at least one of location, capacity, current driving direction, vehicle model, or other features of service vehicle 30.

In various disclosed embodiments, communication interface 102 may be an integrated services digital network (ISDN) card, cable modem, satellite modem, or a modem to provide a data communication connection between server 100 and other devices, such as passenger terminal 200 and communication device 300. As another example, communication interface 102 may be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network 90. Network 90 may typically include a cellular communication network, a Wireless Local Area Network (WLAN), a Wide Area Network (WAN), or the like.

Processor 104 may be one or more known processing devices, such as a microprocessor from the Pentium™ family manufactured by Intel™ or the Turion™ family manufactured by AMD™. Processor 104 may constitute a single core or multiple core processors that executes parallel processes simultaneously. For example, processor 104 may be a single core processor configured with virtual processing technologies. In certain embodiments, processor 104 may use logical processors to simultaneously execute and control multiple processes. Processor 104 may implement virtual machine technologies, or other known technologies to provide the ability to execute, control, run, manipulate, store, etc. multiple software processes, applications, programs, etc. In another embodiment, processor 104 may include a multiple-core processor arrangement (e.g., dual, quad core, etc.) configured to provide parallel processing functionalities to allow server 100 to execute multiple processes simultaneously. One of ordinary skill in the art would understand that other types of processor arrangements could be implemented that provide for the capabilities disclosed herein.

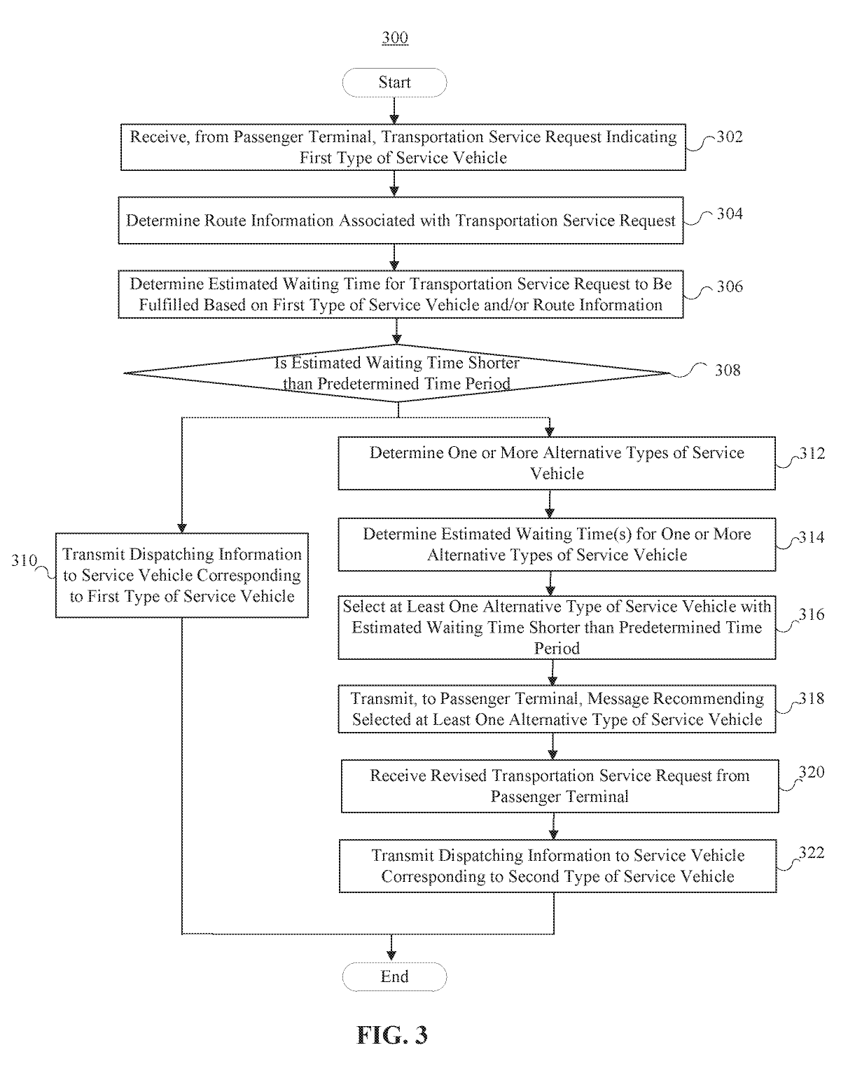

Processor 104 may execute computer instructions (program codes) stored in storage unit 106 and memory module 108, and may perform functions in accordance with exemplary techniques described in this disclosure. More exemplary functions of processor 104 will be described later in relation to FIG. 3.

Storage unit 106 and memory module 108 may include any appropriate type of mass storage provided to store any type of information that processor 104 may need to operate. Storage unit 106 and memory module 108 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Storage unit 106 and/or memory module 108 may be configured to store one or more computer programs that may be executed by processor 104 to perform exemplary functions for dispatching vehicles, as disclosed in this application. Storage unit 106 and/or memory module 108 may be further configured to store information and data used by processor 104.

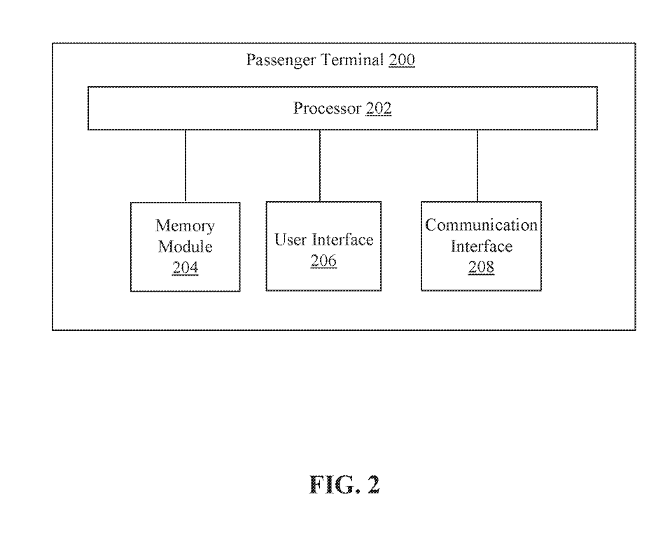

FIG. 2 is a schematic diagram illustrating an exemplary passenger terminal 200, according to an exemplary embodiment. As shown in FIG. 2, passenger terminal 200 may include a processor 202, a memory module 204, a user interface 206, and a communication interface 208.

In exemplary embodiments, processor 202 may include any appropriate type of general purpose or special-purpose microprocessor, digital signal processor, or microprocessor. Processor 202 may be configured as a separate processor module dedicated to performing the disclosed methods for providing information relating to a transportation service. Alternatively, processor 202 may be configured as a shared processor module for performing other functions of passenger terminal 200 unrelated to the disclosed methods for providing information relating to a transportation service. In the exemplary embodiments, processor 202 may execute computer instructions (program codes) stored in memory module 204, and may perform functions in accordance with exemplary techniques described in this disclosure.

Memory module 204 may include any appropriate type of mass storage provided to store any type of information that processor 202 may need to operate. Memory module 204 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory module 204 may be configured to store one or more computer programs that may be executed by processor 202 to perform the disclosed methods for providing information relating to a transportation service.

User interface 206 may include a display panel. The display panel may include a liquid crystal display (LCD), a light-emitting diode (LED), a plasma display, a projection, or any other type of display, and may also include microphones, speakers, and/or audio input/outputs (e.g., headphone jacks).

User interface 206 may also be configured to receive input or commands from passenger 20. For example, the display panel may be implemented as a touch screen to receive input signals from the user. The touch screen includes one or more touch sensors to sense touches, swipes, and other gestures on the touch screen. The touch sensors may not only sense a boundary of a touch or swipe action, but also sense a period of time and a pressure associated with the touch or swipe action. Alternatively or in addition, user interface 206 may include other input devices such as keyboards, buttons, joysticks, and/or tracker balls. User interface 206 may be configured to send the user input to processor 202.

Communication interface 208 can access a wireless network, e.g., network 90, based on one or more communication standards, such as WiFi, LTE, 2G, 3G, 4G, 5G, etc. Communication interface 208 may have a configuration similar to communication interface 102. As described in more detail below, communication interface 208 may be configured to send vehicle information to server 100 and receive vehicle-dispatching information from server 100.

The structures of communication device 300 are similar to those of passenger terminal 200, which will not be repeated herein. It is to be understood that the configuration and boundaries of the functional building blocks of system 10 (FIG. 1) have been defined herein for the convenience of the description. Alternative boundaries may be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 3 is a flowchart of an exemplary method 300 for providing transportation service, according embodiments of the present disclosure. For example, method 300 may be performed by server 100. Referring to FIG. 3, method 300 may include the following steps.

In step 302, server 100 may receive, from passenger terminal 200, a transportation service request including information regarding a first type of service vehicle. The transportation service request may be transmitted from passenger terminal 200 to server 100 via network 90. The first type of service vehicle may be selected by passenger 20. The information regarding the requested type of service vehicle may indicate passenger limit, vehicle model (e.g., SUV minivan, sedan, hybrid, electric, etc.), or vehicle brand (e.g., Toyot™, Honda™, BMW™, Mercededs™, Audi™, etc.) of a service vehicle 30. The transportation service request may also include information indicating a current location of passenger 20, an origin and a destination of the requested transportation service, a request time, or the like.

In step 304, server 100 may determine route information associated with the transportation service request. The route information may include the shortest route between the origin and the destination, route(s) with traffic congestion, route(s) with most traffic lights, etc. In some embodiments, the route information may be determined by passenger terminal 200 and transmitted by passenger terminal 200 to server 100. Alternatively or additionally, server 100 may determine the route information based on the transportation service request (e.g., information indicating the current location of passenger 20, the origin and destination of the requested transportation service, the request time, etc.). For example, server 100 may store map data of a given geographic region, and calculate the shortest route based on the map data and the origin and destination of the requested transportation service. Server 100 may also retrieve current traffic data from a database (e.g., a database maintained by a traffic control center or a third-party traffic service provider) and optimize the calculated route with the current traffic condition. For example, server 100 may modify the calculated route to avoid traffic congestion and/or traffic lights.

In step 306, server 100 may determine an estimated waiting time for the transportation service request to be fulfilled based on the first type of service vehicle and/or the route information. Specifically, server 100 may determine the current demand and supply of the first type of service vehicle. Server 100 may then determine the estimated waiting time based on the demand-supply information, as well as the calculated route and the current position of passenger 20. For example, if currently there is a shortage of the first type of service vehicle, server 100 may place the transportation request in a queue, and determine the estimated waiting time based on the time needed by a first available service vehicle 20 corresponding to the first type of service vehicle to pick up passenger 20.

In step 308, server 100 may compare the estimated waiting time to a predetermined time period. Server 100 may set the predetermined time period according to historical data indicating the average waiting time for the first type of service vehicle and/or user survey indicating the maximum waiting time that can be accepted by average passengers.

When the estimated waiting time is shorter than the predetermined time period (i.e., the estimated waiting time is within a reasonable range), server 100 may proceed to step 310 to transmit dispatching information to a service vehicle 30 corresponding to the first type of service vehicle. The dispatching information may instruct service vehicle 30 to pick up passenger 20 at a designated location and fulfill the transportation service request.

However, when the estimated waiting time is equal to or longer than the predetermined time period (i.e., the estimated waiting time is outside the reasonable range), server 100 may proceed to step 312 to determine one or more alternative types of service vehicle. As described above, the disclosed online hailing platform may provide multiple different types of transportation service (and different types of service vehicle). Thus, server 100 may select one or more types of service vehicle that are different from the first type of service vehicle but could be used to substitute the first type of service vehicle. In some embodiments, the selected alternative type(s) of service vehicle may be similar to the first type of service vehicle on at least one of passenger limit, vehicle model, vehicle brand, etc. For example, if the first type of service vehicle is a six-seat Honda™ Pilot™ SUV, server 100 may select a six-seat Toyota™ Siennaa™ minivan as an alternative type of service vehicle, because a passenger choosing a six-seat vehicle likely requires a large vehicle to accommodate her entire family. As another example, if the first type of service vehicle is a LEXUS™, server 100 may select a BMW™ as an alternative type of service vehicle, because the passenger likely can accept the fare for a luxury car.

Following step 312, server 100 may proceed to step 314 to determine estimated waiting time(s) for the one or more alternative types of service vehicle. Similar to step 306, server 100 may determine the estimated waiting time(s) for the transportation service request to be fulfilled by the one or more alternative types of service vehicle, based on the current demand and supply of the one or more alternative types of service vehicle, the route information, and the current position of passenger 20.

Following step 314, server 100 may proceed to step 316 to select at least one alternative type of service vehicle with an estimated waiting time shorter than the predetermined time period. As described below in connection with step 318, the selected type service vehicle has a shorter estimated waiting time than the first type of service vehicle and thus can fulfill the transportation service request faster. Therefore, the passengers' user experience can be improved.

In some embodiments, to further improve passengers' user experience, server 100 may select the at least one alternative type of service vehicle based additionally on passenger 20's past preference on the types of service vehicle. Specifically, server 100 may determine historical data indicating transportation service requests generated from passenger terminal 200. Based on the historical data, server 100 may determine passenger 20's usage rate (i.e., usage frequency) of each of the types of service vehicle provided by the online hailing platform. Server 100 may then select at least one alternative type of service vehicle which both has an estimated waiting time shorter than the predetermined time period and has a usage rate higher than a predetermined usage rate. In this way, server 100 may ensure the selected alternative type of service vehicle is also a type of service vehicle generally preferred by passenger 20,

Following step 316, server 100 may proceed to step 318 to transmit, to passenger terminal 200, a message recommending the selected at least one type of service vehicle. The message may indicate the estimated waiting times for the first type of service vehicle and the selected at least one type of service vehicle. As described in more detail in connection with method 400, passenger terminal 200 may generate a prompt indicating the selected at least one type of service vehicle has a shorter waiting time than the first type of service vehicle and recommending the selected at least one type of service vehicle to passenger 20.

In some embodiments, when receiving the message recommending the selected at least one type of service vehicle, passenger 20 may revise the transportation service request to change the type of service vehicle. Therefore, at step 320, after the message recommending the selected at least one type of service vehicle is transmitted to passenger terminal 20, server 100 may further receive a revised transportation service request from passenger terminal 20. The revised transportation service request may indicate a second type of service vehicle different from the first type of service vehicle. In some cases, passenger 20 may revise the transportation service request to select a recommended type of service vehicle. As such, the second type of service vehicle belongs to the selected at least one type of service vehicle. In other cases, passenger 20 may decide to use a type of service vehicle different from both the first type of service vehicle and the selected at least one type of service vehicle. The present disclosure does not limit the way how passenger 20 chooses the second type of service vehicle. Moreover, it is contemplated that the revised transportation service request may be in the form of a modification to an existing transportation service request, or in the form of a completely new transportation service request after passenger 20 cancels the previous transportation service request.

Following step 320, server 100 may proceed to step 322 to transmit dispatching information to a service vehicle 30 corresponding to the second type of service vehicle. The dispatching information may instruct service vehicle 30 to pick up passenger 20 at a designated location and fulfill the transportation service request.

According to method 300, a passenger is given the chance to choose a type of service vehicle and/or route that has a shorter waiting time. Therefore, the passenger's user experience can be improved and the available transportations capacity can be used more efficiently.

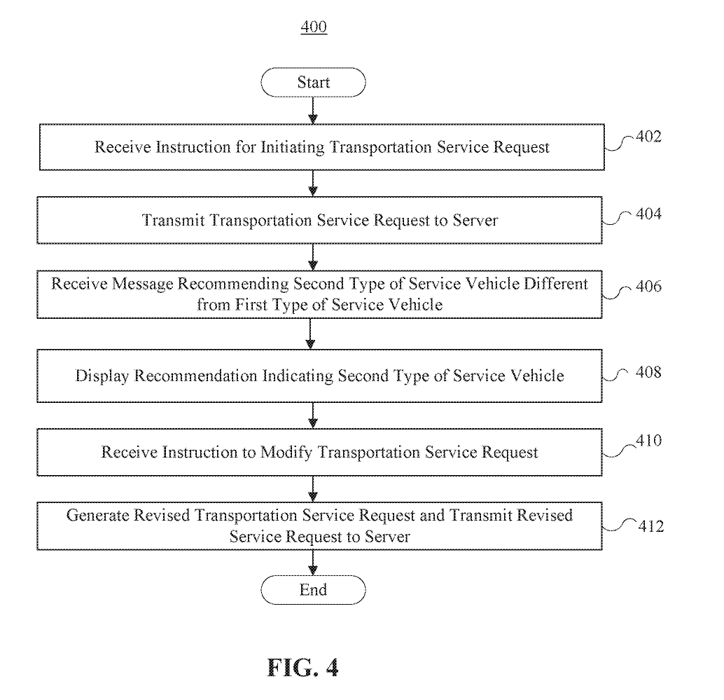

FIG. 4 is a flowchart of an exemplary method 400 for providing transportation service, according to embodiments of the present disclosure. For example, method 40) may be performed by passenger terminal 200. Referring to FIG. 4, method 400 may include the following steps.

In step 402, passenger terminal 200 may receive, via user interface 206, an instruction from passenger 20 for initiating a transportation service request. For example, passenger terminal 200 may be installed with an application for booking a service vehicle 30 through the disclosed online hailing platform. To book a car, passenger 20 may activate the application and select a type of transportation service, such as taxi, private car, carpooling, premium car service, etc. Each type of transportation service may have its designated type of service vehicle. Alternatively or additionally, passenger 20 may directly select the type of service vehicle to be used. Passenger 20 may also input an origin and a destination of the requested transportation service, a request time, or the like.

In step 404, passenger terminal 200 may transmit the transportation service request to server 100 via network 90. The transportation service request may indicate a first type of service vehicle selected by passenger 20, an origin and a destination of the requested transportation service, a request time, etc.

In step 406, passenger terminal 200 may receive, from server 100, a message recommending a second type of service vehicle different from the first type of service vehicle. Server 200 may determine the second type of service vehicle according to method 300, which is not repeated herein.

In step 408, passenger terminal 200 may display, on user interface 206, recommendation information indicating the second type of service vehicle. The recommendation information may also indicate the estimated waiting times for both the first and second types of service vehicle. The recommendation information may further prompt passenger 20 to switch from the first type of service vehicle to the second type of service vehicle, to shorten the waiting time.

In step 410, passenger terminal 200 may receive, via user interface 206, an instruction from passenger 20 to modify the initial transportation service request. For example, passenger terminal 200 may display, on user interface 206, a selection menu for passenger 20 to select the second type of service vehicle.

In step 412, passenger terminal 200 may generate a revised transportation service request based on the instruction of passenger 20 and transmit the revised transportation service request to server 100. The revised transportation service request may indicate a new type of service vehicle selected by passenger 20, e.g., the second type of service vehicle. Server 100 may then send dispatching information to a service vehicle 20 corresponding to the new type of service vehicle, to instruct the service vehicle 20 to pick up passenger 20.

According to method 400, a passenger is given the chance to choose a type of service vehicle and/or route that has a shorter waiting time. Therefore, the passenger's user experience can be improved and the available transportations capacity can be used more efficiently.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
receiving, from a passenger terminal, a transportation service request indicating a first type of service vehicle;
determining route information associated with the transportation service request;
determining an estimated waiting time for the transportation service request to be fulfilled based on the first type of service vehicle and the route information;
comparing the estimated waiting time to a predetermined time period;
when the estimated waiting time is equal to or longer than the predetermined time period, determining a second type of service vehicle, wherein the second type of service vehicle has an estimated waiting time shorter than the predetermined time period; and
transmitting, to the passenger terminal, a message recommending the second type of service vehicle.

2. The method of claim 1, wherein determining the second type of service vehicle comprises:
determining estimated waiting times corresponding to a set of different types of service vehicles respectively, based on the route information; and
identifying, from the set of different types of service vehicles, the second type of service vehicle with an estimated waiting time shorter than the predetermined time period.

3. The method of claim 2, wherein identifying, from the set of different types of service vehicles, the second type of service vehicle with an estimated waiting time shorter than the predetermined time period further comprises:
determining historical data regarding transportation service requests generated from the passenger terminal;
determining usage rates of the set of different types of service vehicles, based on the historical data; and
identifying, from the set of different types of service vehicles, the second type of service vehicle based additionally on the usage rates of the set of different types of service vehicles.

4. The method of claim 3, wherein the second type of service vehicle has a usage rate higher than a predetermined rate.

5. The method of claim 1, further comprising:
after the message recommending the alternative type of service vehicle is transmitted, receiving a revised transportation service request from the passenger terminal;
determining a third type of service vehicle based on the revised transportation service request; and
transmitting dispatching information to a service vehicle corresponding to the third type of service vehicle.

6. The method of claim 1, further comprising:
when the estimated waiting time is shorter than the predetermined time period, transmitting dispatching information to a service vehicle corresponding to the first type of service vehicle.

7. The method of claim 1, wherein the first type of service vehicle and second type of service vehicle are differing in at least one of passenger limit, vehicle model, or vehicle brand of a service vehicle.

8. A device for providing transportation service, comprising:
a communication interface in communication with a passenger terminal;
a memory storing instructions; and
a processor coupled to the communication interface and the memory, the processor configured to execute the instructions to:
receive, via the communication interface, a transportation service request from the passenger terminal, the transportation request indicating a first type of service vehicle;
determine route information associated with the transportation service request;
determine an estimated waiting time for the transportation service request to be fulfilled based on the first type of service vehicle and the route information;
compare the estimated waiting time to a predetermined time period;
when the estimated waiting time is equal to or longer than the predetermined time period, determine a second type of service vehicle, wherein the second type of service vehicle has an estimated waiting time shorter than the predetermined time period; and
transmit, via the communication interface, a message recommending the second type of service vehicle to the passenger terminal.

9. The device of claim 8, wherein the processor is further configured to:
determine estimated waiting times corresponding to a set of different types of service vehicles respectively, based on the route information; and
identify, from the set of different types of service vehicles, the second type of service vehicle with an estimated waiting time shorter than the predetermined time period.

10. The device of claim 9, wherein the processor is further configured to:
determine historical data regarding transportation service requests generated from the passenger terminal;
determine usage rates of the set of different types of service vehicles, based on the historical data; and
identify, from the set of different types of service vehicles, the second type of service vehicle based additionally on the usage rates of the set of different types of service vehicles.

11. The device of claim 10, wherein the second type of service vehicle has a usage rate higher than a predetermined rate.

12. The device of claim 8, wherein the processor is further configured to:
after the message recommending the alternative type of service vehicle is transmitted, receive, via the communication interface, a revised transportation service request from the passenger terminal;
determine a third type of service vehicle based on the revised transportation service request; and
transmit, via the communication interface, dispatching information to a service vehicle corresponding to the third type of service vehicle.

13. The device of claim 8, wherein the processor is further configured to:
when the estimated waiting time is shorter than the predetermined time period, transmit, via the communication interface, dispatch information to a service vehicle corresponding to the first type of service vehicle.

14. The device of claim 8, wherein the first type of service vehicle and second type of service vehicle are differing in at least one of passenger limit, vehicle model, or vehicle brand of a service vehicle.

15. A non-transitory computer-readable medium that stores a set of instructions, when executed by at least one processor, causing the at least one processor to perform a method for providing transport service, the method comprising:
receiving, from a passenger terminal, a transportation service request indicating a first type of service vehicle;
determining route information associated with the transportation service request;
determining an estimated waiting time for the transportation service request to be fulfilled based on the first type of service vehicle and the route information;
comparing the estimated waiting time to a predetermined time period;
when the estimated waiting time is equal to or longer than the predetermined time period, determining a second type of service vehicle, wherein the second type of service vehicle has an estimated waiting time shorter than the predetermined time period; and
transmitting, to the passenger terminal, a message recommending the second type of service vehicle.

16. The non-transitory computer-readable medium of claim 15, wherein determining the second type of service vehicle comprises:
determining estimated waiting times corresponding to a set of different types of service vehicles respectively, based on the route information; and
identifying, from the set of different types of service vehicles, a type of service vehicle with an estimated waiting time shorter than the predetermined time period.

17. The non-transitory computer-readable medium of claim 16, wherein identifying, from the set of different types of service vehicles, the type of service vehicle with an estimated waiting time shorter than the predetermined time period further comprises:
determining historical data regarding transportation service requests generated from the passenger terminal;
determining usage rates of the set of different types of service vehicles, based on the historical data; and
identifying, from the set of different types of service vehicles, the second type of service vehicle based additionally on the usage rates of the set of different types of service vehicles.

18. The non-transitory computer-readable medium of claim 17, wherein the second type of service vehicle has a usage rate higher than a predetermined rate.

19. The non-transitory computer-readable medium of claim 15, wherein the method further comprises:
after the message recommending the alternative type of service vehicle is transmitted, receiving a revised transportation service request from the passenger terminal;
determining a third type of service vehicle based on the revised transportation service request; and
transmitting dispatching information to a service vehicle corresponding to the third type of service vehicle.

20. The non-transitory computer-readable medium of claim 15, wherein the method further comprises:
when the estimated waiting time is shorter than the predetermined time period, transmitting dispatching information to a service vehicle corresponding to the first type of service vehicle.
